(19) United States
(12) Patent Application Publication
(10) Pub. No.: US 2026/0135742 A1
(43) Pub. Date: May 14, 2026

(54) High throughput communication system for rail applications at 44MHz

(71) Applicant: Meteorcomm, LLC, Renton, WA (US)

(72) Inventors: Thanongsak Himsoon, Kent, WA (US); Wipawee Siriwongpairat, Kent, WA (US); Mark Davies, Anlaby (GB)

(21) Appl. No.: 19/243,642

(22) Filed: Jun. 19, 2025

Related U.S. Application Data
(60) Provisional application No. 63/661,851, filed on Jun. 19, 2024.

(51) Int. Cl. H04L 27/20; B61L 15/00; H04B 1/00; H04W 72/0453

(52) U.S. Cl. CPC H04L 27/2017; H04B 1/0003; H04L 27/2071; H04W 72/0453; B61L 15/0027

(57) ABSTRACT

A rail communication system supporting higher data rate in wireless data communications in 20 kHz channels in the 44 MHz band for railroad applications using any one or more of the following: higher data rate modulations, robust demodulations, and more efficient over-the-air protocols.

### TECHNICAL FIELD

The present disclosure relates to railroad wireless communication systems for transport of data for railroad applications.

### BACKGROUND

In the United States, some railroads are using a low-VHF frequency, narrowband channel to transmit data for application programs that are part of systems that enhance safety or operational efficiency of railroad operations centered at 44.58 MHz. The Hy-Rail Limit Compliance System (HLCS) of the Burlington Northern Santa Fe (BNSF) railway is one example of such a system. The HLCS supports dispatching and operating “Hy-Rail” vehicles or, more generally, “hi-rail” vehicles on railroad tracks. A hi-rail vehicle is a motor vehicle or machine made for travel over roadways that is outfitted with flanged wheels so that the vehicle can also travel on railroad tracks. Such vehicles are typically used by crews that maintain, for example, tracks, rights-of-way, crossings, and wayside systems and equipment. The HLCS tracks the position of hi-rail vehicles using a global navigation satellite system (GNSS) receiver in the vehicle. An example is a Global Positioning System (GPS) receiver. A radio in the vehicle transmits position information obtained using the GNSS system to a base station radio positioned alongside the railroad track, which then forwards the packet to a back or central office of the railroad, or its network operations center (NOC). When a hi-rail vehicle is approaching or has exceeded its authorization limits on a railroad track, the HLCS is programmed to send automatically warning messages to the operator of the hi-rail vehicle and the train dispatcher responsible for controlling use of the track. A track authorization limit from a dispatcher authorizes the hi-rail operator to be on a particular block of track. The HLCS can also automatically issue warnings to a hi-rail vehicle when it is near another hi-rail vehicle, train, or a locomotive.

Under the frequency allocation scheme of the US Federal Communication Commission (FCC), frequencies around 44 MHz, such frequencies between 42 MHz and 50 MHz, are predominately allocated for use by private land mobile services. The use of these frequencies for land mobile radio services in the US is governed by FCC regulations found in Part 90 of Title 47 of the Code of Federal Regulations.

The radios used by railroads that are configured to operate on a single, low-VHF frequency channel of 44.58 MHz in half-duplex mode. The radios are configured to be limited to a data rate of 9.6 kilobits per second (kbps) in a 20 kilohertz (kHz) channel using mostly unorganized transmissions. Frequencies around 44 MHz, such as between 42 MHz to 50 MHz region, provide good RF penetration and outdoor coverage for a given transmission power. The frequency channels for mobile land radio use in this region are typically limited to 20 kHz for more efficient use of the spectrum. 20 kHz is considered a relatively narrow bandwidth. The narrow bandwidth substantially limits data rates. However, narrow bandwidth channels can have relatively longer ranges, lower power requirements, and less sensitivity to certain types of interference, any of which can enhance reliability and robustness of transmissions, which are attributes needed for RF communications in a railroad environments.

### SUMMARY

The 9.6 kbps data rate of current 44 MHz radios used by railroads limits the number and type of railroad applications that railroads can use in the 44 MHz band. Examples of railroad applications include software implemented processes on devices located on, in, or next to, or used by, railroad assets such as locomotives, rail cars, hi-rail vehicles, equipment along the track or in the wayside (for example, signaling systems, switches, and crossing barriers, and detectors), and any other type of fixed or mobile equipment for railroad operation or maintenance.

Disclosed herein are train control radios that are configured to transmit and/or receive RF data packets containing railroad application data in one or more narrowband channels in the 44 MHz spectral band. The train control radios may embody one or more representative examples of apparatus and methods for transmitting RF data packets containing railroad application data that can be used to increase the capacity of a 20 MHz channel in the 44 MHz band. The increased capacity can be used to support more use of such channels by railroad applications while meeting the high level of reliability and robustness required to support communications in a railroad environments between different types of railroad assets and complying with regulatory requirements on channels in the 44 MHz band. The apparatus and methods can increase throughput on a channel in the 44 MHz band consistent with these limitations using any one or more of the following: higher data rate modulations, more robust demodulation, and a more efficient over-the-air protocols.

In one representative, non-limiting example, a software defined radio is configured for wirelessly transmitting wireless data packets in at least one 20 kHz channel of a 44 MHz band, the wireless data packets containing data for railroad applications, the radio including at least one modulator configured to be capable of generating from a sequence of symbols differentially encoded modulated I and Q baseband signals using at least one of Gaussian Minimum Shift Keying (GMSK) modulation with a bandwidth time (BT) product less than 1, differential quadrature phase shift keying (DQPSK) modulation, and differential 8 PSK (D8PSK).

In one representative, non-limiting example, a radio is configured for wirelessly transmitting and receiving wireless data packets in a 44 MHz band with 20 kHz channels, the wireless data packets containing data for railroad applications, the radio includes: at least one transmitter with at least one modulator configured to be capable of generating from a sequence of symbols differentially encoded modulated I and Q baseband signals using at least one of Gaussian Minimum Shift Keying (GMSK) modulation with a bandwidth time (BT) product of 1, GMSK modulation with a BT product less than 1, differential quadrature phase shift keying (DQPSK) modulation, and differential 8 PSK (D8PSK); and at least one receiver configured to receive transmissions in at least one 20 kHz channel in the 44 MHz band, the at least receiver including at least one radio frequency demodulator configured to be capable of demodulating modulated I and Q baseband signals modulated and generating a sequence of transmitted symbols, the modulated I and Q baseband signals being modulated with at least one of the following modulation types: Gaussian Minimum Shift Keying (GMSK) modulation with a bandwidth time BT product of 1, GMSK modulation with a bandwidth time BT product less than 1, differential quadrature phase shift keying (DQPSK) modulation, and differential 8 PSK (D8PSK) modulation; wherein the radio further configured to be capable of transmitting wireless data packet in slots of 20 kHz time division multiple access (TDMA) channels in the 44 MHz band and is further configured to be capable of transmitting wireless data packets in 20 kHz channels carrier sense multiple access (CSMA) channels in the 44 MHz band.

In one representative, non-limiting example, a method for a 44 MHz band communication that supports using 44 MHz radios located at railroad assets to transmit wireless data packets containing data for railroad in 20 kHz channels in the 44 MHz band of railroad application data at transmit data rates greater than 9600 bps, the method including generating from a sequence of symbols differentially encoded modulated I and Q baseband signals using at least one of Gaussian Minimum Shift Keying (GMSK) modulation with a bandwidth time (BT) product less than 1, differential quadrature phase shift keying (DQPSK) modulation, and differential 8 PSK (D8PSK); and receiving and demodulating wireless data packets containing data for railroad applications in a 20 kHz channel of the 44 MHz band that have been modulated with Gaussian Minimum Shift Keying (GMSK) modulation with a bandwidth time (BT) product less than 1, differential quadrature phase shift keying (DQPSK) modulation, or differential 8 PSK (D8PSK) modulation.

### BRIEF DESCRIPTION OF THE DRAWINGS

FIG. 1 illustrates a representative example of a railroad environment.

FIG. 2 illustrates a representative example of a generic vehicle equipped with a radio communication system on a railroad track.

FIG. 3 illustrates a representative example of a train control network.

FIG. 4 illustrates a representative example of digital packet structure.

FIG. 5 schematically illustrates a representative example of a GMSK modulator.

FIG. 6 is a chart plotting frequency and power to illustrate a representative example of a GMSK waveform with a transmit data rate of 9600 bits per second (bps) and a BT product of 1.

FIG. 7 is a chart plotting frequency and power to illustrate a representative example of a GMSK waveform with a transmit data rate of 19200 bps and a BT product of 0.3.

FIG. 8 is a flow chart illustrating a representative example of a GMSK detection algorithm.

FIG. 9 is schematic illustration of a representative example Pi/4 DQPSK modulator.

FIG. 10 is a chart plotting frequency and power to illustrate a representative example of a Pi/4 DQPSK waveform with a transmit data rate of 9600 bps and an RRC filter roll-off 0.35.

FIG. 11 is a chart plotting frequency and power to illustrate a representative example of a Pi/4 DQPSK waveform with a transmit data rate of 19200 bps and an RRC filter roll-off 0.35.

FIG. 12 is a chart plotting frequency and power of a representative example of a Pi/4 DQPSK waveform with a transmit data rate of 30000 bps and an RRC filter roll-off 0.35.

FIGS. 13 and 14 are flow charts illustrating representative and nonlimiting examples of processes of a base radio and a remote radio, respectively, to transmit a packet using centralized communication.

FIGS. 15 and 16 are each a flow chart illustrating representative and nonlimiting examples of processes that a base radio and a remote radio may use when receiving packet using centralized communication and, in the case of a remote radio, when decentralized communication is being used or supported.

FIG. 17 is a flow chart illustrating a representative example of decentralized communication transmission processes for a radio.

FIG. 18 is a flow chart illustrating a representative, nonlimiting example of a demodulation process 1600 for a 44 MHz radio receiver to demodulate DQPSK, including Pi/4 DQPSK, modulated signals using a modular implementation of an SDR demodulator.

### DETAILED DESCRIPTION

Unless indicated otherwise, the following terms have the ascribed meanings in the description of the figures:

A “radio” is a device that includes a radio frequency transmitter, a radio frequency receiver, both a transmitter and a receiver (or transceiver.) A “transceiver” refers to a device that has both an RF transmitter and RF receiver. A “remote radio” refers to a radio that is not at a base station radio (“base radio.”) A remote radio may be fixed or mobile. A transmitter and receiver in a radio may, but do not have to, share analog RF stage components, such as antennas, amplifiers, and mixers. Similarly, they may share processors, user interfaces, network interfaces, and other I/O components. Multiple transmitters and/or multiple receivers may also share components.

A “software defined radio” (SDR) transmits, receives, and processes information in a binary digital form, meaning as a series of bits. It uses software to implement processes that in conventional radios are implemented using analog components. Representative, nonlimiting examples of such hardware components are modulators, demodulators, filters, and mixers. The functionality of these components can be implemented by software-controlled processes. The software runs on one or more programmable hardware circuits specially designed for these types of processes, such as digital signal processors (DSP) and field programmable gate arrays (FPGA). However, general-purpose processors can also be used. Multiple digital and some analog circuits can be integrated into a single, monolithic substrates or “chips.” In addition to hardware for executing these processes, an SDR will also have additional hardware, such as memory for storage, analog to digital (ADC), and digital to analog (DAC) converters, interfaces, power supplies, and radio frequency amplifiers. An SDR provides several advantages, including multi-channel capability and the ability to adapt to different channel conditions.

A “rail vehicle” refers to any type of transportation vehicle configured to travel on railroad tracks. A “locomotive” is a type of rail vehicle that provides power to move a series of connected rail vehicles (a “train”) on a railroad. A “car” or “railroad car” generally refers to a rail vehicle for carrying passengers or freight. A “hi-rail” refers to a vehicle or machine capable of traveling on roads or over the ground that has been converted or is capable of being converted to travel on railroad tracks. Such vehicles are, for example, fitted with retractable flanged wheels. Deploying the flanged wheels allows the vehicle to travel on railroad tracks. Retracting them allows the vehicle to leave the tracks and travel on land without the tracks. The non-retractable flanged rails can also be installed or fitted to road vehicles and machines to convert them to rail vehicles.

A “back office” (BO) refers to one or more facilities containing computer or data network infrastructure that support railroad operations, including computing systems hosting servers for railroad applications. A “central office” (CO) generally refers to one or more facilities from which dispatchers of railroad monitor and authorize movement of trains and other rail vehicles on its tracks. A railroad may have a network operations center (NOC) that oversees and controls traffic on all its tracks. The same facility may function as a BO, CO, and NOC. A reference to one of these facilities should be interpreted as a reference to any of them unless contrary to the context.

A “44 MHz radio” and “44 MHz RF communication system” refer to, respectively, wireless packet data radios and networks (or more generally communication systems) capable of transmitting or receiving data packets for railroad applications on frequencies in the 44 MHz band.

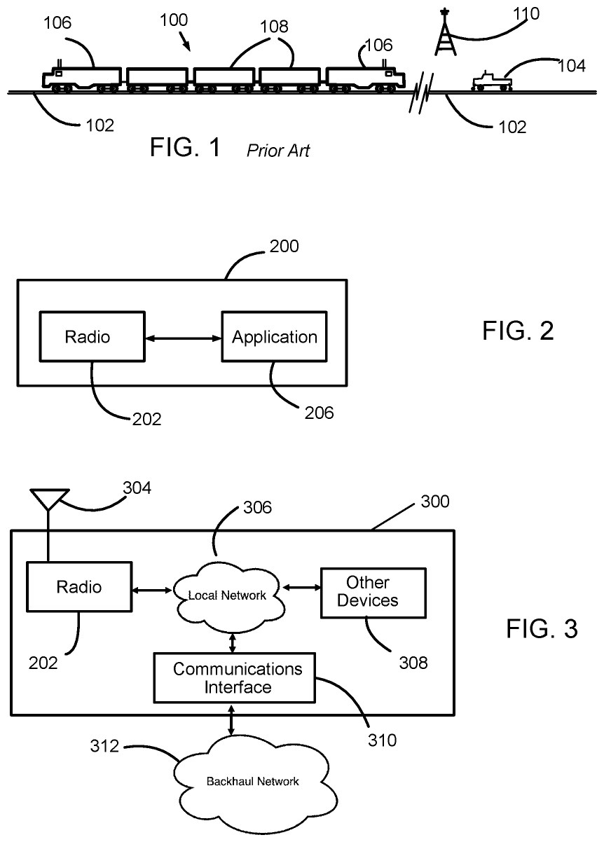

FIG. 1 contains a simple, schematic representative example of a train 100 on a section of a railroad track 102 and a hi-rail vehicle 104 on a different section of the railroad tracks 102. This example of a train includes two locomotives 106, one of which is a is at the head of the train and the other is at the end of the train, and several rail cars 108. However, a train may have any number of configurations and lengths. Base station 110 is a representative example of a base station positioned near the track. This base station includes a digital base radio configured to operate in the 44 MHz band and to be capable of communicating with remote radios used by railroad assets within its range, including mobile remote radios of rail vehicles and fixed remote radios for wayside and other equipment.

FIG. 2 contains a representative example of a rail vehicle 200 that is equipped with one or more radio systems. The vehicle 200 could be, for example, a hi-rail vehicle, locomotive, or another rail car that is located or moving on a railroad track (not shown). It could also be a hi-rail vehicle not on the railroad track but near one. On board the rail vehicle is a remote radio 202. The rail vehicle may have additional radios. In this example, remote radio 202 is mobile remote radio configured to operate in at least one 20 kHz channel in the 44 MHz band.

The remote radio can be, for example, a single unit that includes both receiving and transmitting functionality, a “transceiver,” or a combination of separate receiving and transmitting units. Remote radio 202 connects to an antenna 304 to transmit and receive radio frequency signals used to transport in wireless data packets data generated by or intended for an on-board railroad application. Application 206 is a representative of any one or more applications that communicate with the radio to send and/or receive data. The radio may connect to multiple antennas. More than one on board radio may connect to the same antenna. Remote radio 202 provides at least one wireless communications path for transporting messages sent from or to one or more local applications on board the rail vehicle. The radio can be configured to host one or more of these applications, or it can be configured to communicate with other devices that host them through a direct connection or a network interface. The radio may also be configured to communicate with other on-board devices or processes hosted locally through either a direct connection or a network interface.

Remote radio 202 is configured to communicate with a base station radio and other remote radios. However, it could be configured to communicate with only a base station or another remote radio.

FIG. 3 illustrates a representative example of a base station 300 that is configured to or is otherwise capable of wirelessly communicating with remote radios within its range or assigned area. The remote radios can be either mobile or fixed. It is, in this example, part of a network a geographically distributed base stations that collectively form wireless access network for transporting data to and from users of remote radios, particularly mobile uses, which are capable of wirelessly transmitting and receiving signal with the base stations. These include remote radios on rail vehicles. Each base station is configured to transport or is capable of transporting data messages between a remote application and an application or service hosted by a server at a railroad central office, data center, or location that is connected to the networks to which the base is connected.

The representative base station 300 has at least one radio 302 (a “base radio”) configured to communication with, for example a remote radio, such as mobile remote radio 202 in a rail vehicle within its operating area. In this example, radio 302 is configured to operate in at least one 20 kHz channel in the 44 MHz band. It may, optionally, be capable of or configured to operate in multiple channels or in multiple frequency ranges or bands. The base station may have additional radios for communicating the 44 MHz band on, for example, other channels, and in other frequency bands. The base radio 302 can be, for example, a single unit that includes both receiving and transmitting functionality—a “transceiver”—or a combination of separate receiving and transmitting units. The radio is connected to at least one antenna 304 and has, for example, a local network interface. The radio may be configured to send and receive data over local network 306 to or from, for example, processes on one or more local devices 308. It may also be configured to send and receive data through one or more communication interfaces, represented by communication interface 310, to remote processes. Examples of communication interfaces include gateway routers, switches, and modems. The communication interface can be configured, for example, to connect the base station over one or more links, represented by network cloud 312, to other base stations and/or one or more other facilities such as central offices, data centers, operations centers communication network. Such links can be wired or wireless.

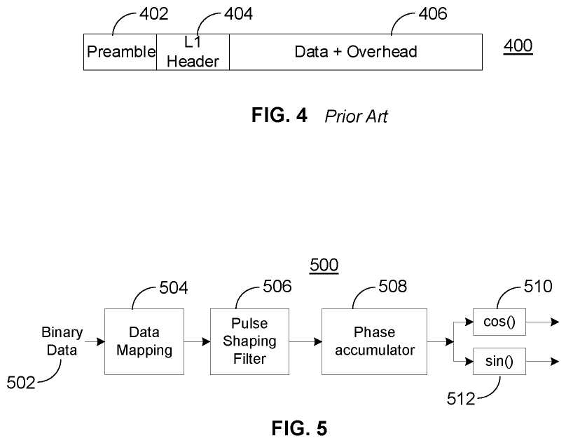

FIG. 4 illustrates a representative example of a packet structure 400 for a 44 MHz radio used for transmitting packet data for railroad applications. Each packet starts with a preamble 402, followed by a data frame that includes, for example, an L1 header 404 followed by data and overhead portion 406. The data and overhead portion 406 may include, in addition to application data, data identifying a packet type (selected from one or more predefined packet types), a source address, a destination addresses, forward error correction (FEC) codes, cyclic redundancy codes (CRC), and/or other information. Packet types may include, for examples, any one or more of the following types: unicast data packets, broadcast data packets, acknowledgement packets, and/other types of packets. The preamble 402 contains a series of sync bits in a predetermined patten that are used by a 44 MHz radio's receiver to establish frame and symbol synchronization and to determine the start of the data frame. The L1 header 404 is a physical layer header that provides physical layer information. Examples of physical layer information may include data rate for the data and overhead portion 406, FEC for the data and overhead, and/or other information. The L1 header 404 is usually, but does not necessarily have to be, transmitted at the same data rate for all packets. The data rate for the data and overhead portion 406 can be higher or lower.

FIGS. 5-12 illustrate and describe representative, nonlimiting examples of modulators and demodulators for a digital 44 MHz radio that transmits and receives wireless packets carrying data for railroad applications in a 20 kHz channel in the 44 MHz frequency spectrum.

These examples assume that 44 MHz radios will be implemented as a software defined radio. A complete software defined digital 44 MHz radio is not illustrated in the figures. In addition to hardware for executing the processes, an SDR will also have additional hardware, such as memory for storage, analog amplifiers and filters for its RF stage, analog to digital (ADC) and digital to analog (DAC) converters, interfaces, and power supplies. An SDR provides several possible advantages, including multi-channel capability and the ability to adapt to different channel conditions.

A representative, nonlimiting example of a software defined 44 MHz radio includes at least one analog radio frequency (RF) stage configured to receive 44 MHz signals and a RF stage configured to transmit 44 MHz coupled with at least one antenna. The radio may include other RF stages that for other frequency bands. The 44 MHz RF stages could be integrated as part of a transceiver or in discrete receiver and transmitters.

A digital radio receiver functions or acts like a conventional radio but processes a digitized version of an RF or IF signal that is frequency division multiplexed (FDM) for an entire band. After the received RF or IF frequency signal is processed by a radio frequency stage, the digital receiver samples the FDM signal using an analog-to-digital converter to generate a discrete, time-invariant signal representing a continuous sequence of samples. The digitized FDM signal is then demodulated and decoded according to the modulation and coding scheme being used by the RF link using a baseband processor that will, in effect, down-convert and filter the sampled FDM signal into separate baseband digital signals corresponding to different predefined channels within the band for detection of data that was transmitted. Similarly, a digital baseband signal (usually as in-phase and quadrature-phase signals) generated according to a particular modulation and coding scheme is used to modulate the phase and/or amplitude of a carrier frequency. A received analog signal may, optionally, be filtered and down converted to an intermediate frequency before it is converted to a stream of digital samples to be handled by one or more programmed baseband processors.

A baseband processor is implemented, for example, by one or more field-programmable gate array (FPGA). However, a baseband processor may alternatively be implemented using a digital signal processor (DSP) or another type of processor, or a combination of FPGA and DSP. References to FPGA should be understood to include alternative implementations such as DSPs or other processors, or combinations of them, which are capable of being programmed as described unless explicitly stated otherwise.

The radio also includes central processing unit (CPU) or “processor,” implemented for example with a microprocessor, executes software implemented processes that control configuration, operation, and communications, including channel access, of the radio. The processor also processes data streams produced by the demodulation and decoding of the baseband processor and generates data streams sent to the baseband process for transmission. The radio's CPU can be, for example, connected to nonvolatile storage in the form of EEPROM to store configuration data; memory for storing application and operating system code, such as flash memory; a working memory, such as RAM. The CPU sends and receives data includes an interface an Ethernet network interface; and a USB data interface. The CPU receives from a local railroad application data in one or more packets for transmission as one or more wireless data packets by the radio in one or more packets. It also forwards application data packets received by the radio for delivery to an application.

Current transmissions in the 44 MHz communication for railroad use employ GMSK BT1 modulation at the transmit data rate of 9600 bps.

A representative, nonlimiting embodiment of a 44 MHz radio that supports higher data rates while providing robust and efficient communication required by a railroad environment in 20 kHz channels that meets regulatory requirements is configured with at least one modulator and/or demodulator configured for higher data modulation, where at least one of the modulators or demodulators uses one of the following modulation schemes: GMSK modulation with BT less than 1, DQPSK (including Pi/4-DQPSK), and D8PSK. Optionally, the 44 MHz radio is configured with GMSK BT1 modulation at the transmit data rate of 9600 bps. A modulator or demodulator for Pi/4-DQPSK, DQPSK, and/or D8PSK may also be configured to support more than one data rate.

FIG. 5 illustrates a representative, nonlimiting example of a modular implementation of a GMSK modulator in a software defined radio. It can be, for example, implemented on a digital signal processor (DSP). GMSK modulator 500 receives as an input a stream of binary data 502, which is a sequence of binary values or bits that will be transmitted, performs GMSK modulation, and outputs a baseband GMSK signal. At block 504, the GMSK modulator maps each bit in the binary data stream to an antipodal (1, −1) or NRZ sequence. The mapping can use table look up. The mapping may, alternatively, be calculated using,

$${b}_{k} = 2 \times {a}_{k} - 1$$

where aₖ represents the value of the bit at position k and bₖ is the output of block 504.

The antipodal sequence is presented as a stream of rectangular impulses with a symbol or bit interval T to a Gaussian pulse shaping filter module 506 to create a filtered GMSK baseband signal g(t). The impulse response of the Gaussian filter for GMSK signal is,

$$g ( t ) = Q [ \frac{2 π B ( t - \frac{T}{2} )}{\sqrt{ln 2}} ] - Q [ \frac{2 π B ( t + \frac{T}{2} )}{\sqrt{ln 2}} ]$$

where,

$$Q ( t ) = \frac{1}{\sqrt{2 π}} {\int }_{t}^{∞} exp ( - \frac{{s}^{2}}{2} ) ds$$

is the Gaussian error function. BT is the product of a bandwidth B of the filter and the symbol or bit interval T.

The output of the Gaussian pulse shaping filter module 506 is then provided to a phase accumulator 508, which differentially encodes it, producing an output, θₖ, which then used to by modules 510 and 512 to generate in-phase u_{I} and quadrature u_{Q} components of for a modulated GMSK baseband signal according to:

$${u}_{I} ( k ) = cos ( {θ}_{k} )$$

$${u}_{Q} ( k ) = sin ( {θ}_{k} )$$

The in-phase and quadrature components of the modulated baseband signal (u_{I} and u_{Q}) are provided to a field programmable (FPGA) through the appropriate interface to generate an RF signal. The output can also be sent directly to the phase increment registers of a direct digital synthesizer (DDS) to generate an analog signal. The analog signal output from the DDS is then sent to an RF module for amplification and RF transmission.

The spectrum of the GMSK waveforms depends on the BT (bandwidth-time) product of the Gaussian filter that is applied to the baseband waveform. The scope of the disclosure includes the GMSK waveforms described herein.

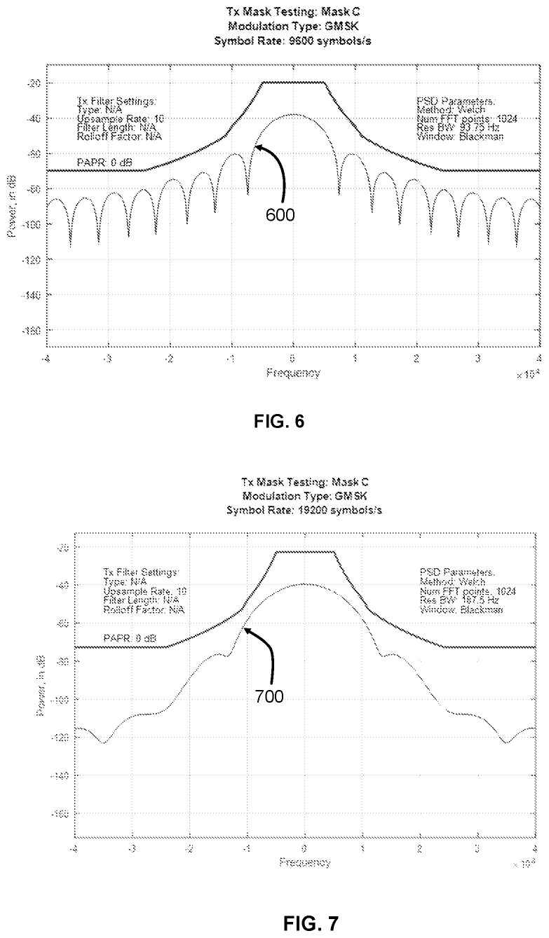

FIG. 6 illustrates a representative example GMSK waveform 600 with a transmit data rate of 9600 bps (9.6 Kbps) and a BT product of 1.

FIG. 7 illustrates a representative example GMSK waveform 700 with a transmit data rate of 19200 bps (19.2 Kbps) and a BT product of 0.3.

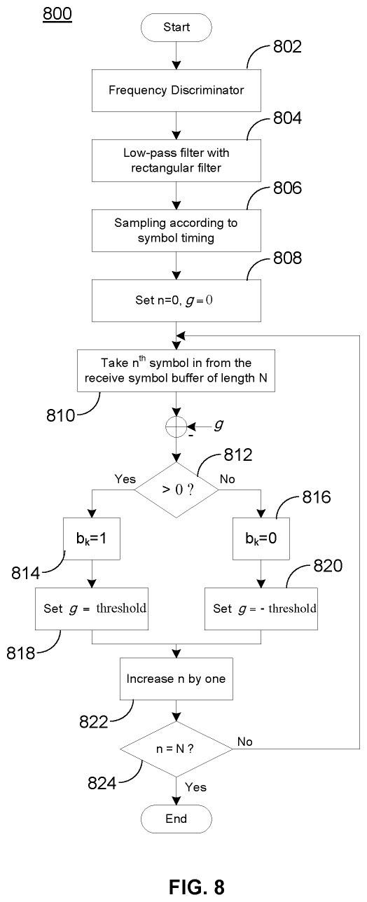

FIG. 8 illustrates a representative example GMSK detection algorithm 800. A GMSK detector performing the GMSK detection algorithm 800 receives sequences of I and Q samples, performs a detection algorithm, and outputs the received binary data. The GMSK detector performs frequency discrimination on the received I and Q samples at block 802. The output of frequency discriminator is low pass filtered by a rectangular filter with a one symbol length at block 804. The output of low-pass filter is sampled according to the symbol timing at block 806 and each sampled value is stored in a received symbol buffer at blocks 808 and 810. For each symbol, the receiver then detects which symbol was received based on the stored sample. The detection is performed iteratively. In an example of a detection method, the detector compares the stored value with a threshold at block 812. In the case of starting with the symbol, the detector decides that the symbol is a binary one if the sampled value is greater than the threshold (see block 814); otherwise, the detector decides that the symbol is a zero at block 816. After a symbol is detected, the detector sets the threshold for the next symbol to be either positive or negative value based on the previously detected symbol at blocks 818 and 820. The threshold is set to a positive value if the detected symbol is one; otherwise, the threshold is as a negative value. The symbol count is increased by one at block 822 and, if more symbols exist in the sequence, the detection process repeats for the next symbol at block 824. Alternative methods to estimate the symbol values in a received transmission.

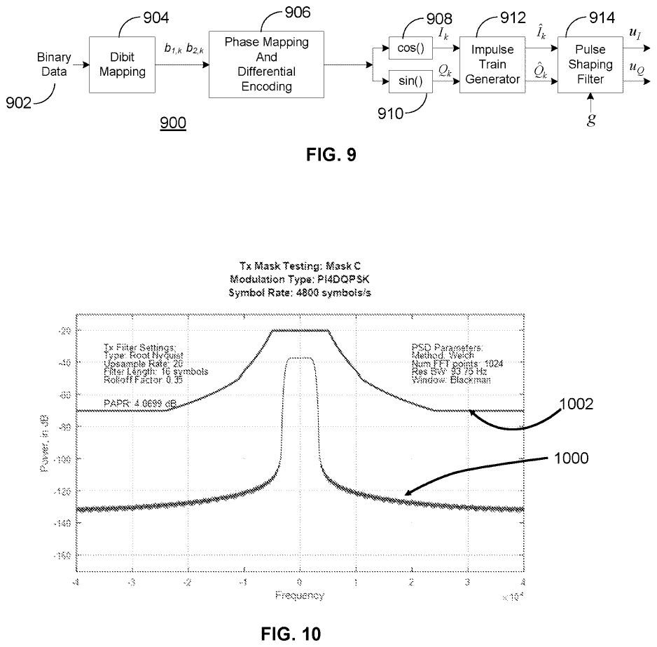

FIG. 9 illustrates a representative, nonlimiting example of Pi/4 DQPSK modulator for a transmitter section of a 44 MHz software defined radio. A bit sequence 902 for transmission is received and stored in a buffer. For example, the DSP receives the bit sequence 902 through the host port interface (HPI) and then modulates it with the Pi/4 DQPSK modulator 900. The DSP implements the modulator as a programmed digital process. With Pi/4 DQPSK modulator, each two consecutive bits, b_{1,k} and b_{2,k}, in the bit sequence are paired into a dibit symbol using mapping block 904. A phase mapping and differentially encoding block 906 generates a signal phase, θₖ, for each symbol k using a look up table. The look up table can be based on Gray code mapping. Table 1 shows a representative example phase mapping for a DQPSK signal.

TABLE 1

| LSB | MSB | Signal Phase |
|---|---|---|
| b_{1, k} | b_{2, k} | θₖ |
| 0 | 0 | π/4 |
| 1 | 0 | 3π/4 |
| 1 | 1 | −3π/4 |
| 0 | 1 | −π/4 |

In-phase Iₖ and quadrature Qₖ components of the pi/4 DQPSK signal corresponding to the k^{th} symbol are generated in modules 908 and 910 from signal phase, θₖ, according to the following relationships:

$${I}_{k} = {I}_{k - 1} cos [ {θ}_{k} ] - {Q}_{k - 1} sin [ {θ}_{k} ]$$

$${Q}_{k} = {I}_{k - 1} sin [ {θ}_{k} ] - {Q}_{k - 1} cos [ {θ}_{k} ]$$

Equivalently, the in-phase Iₖ and quadrature Qₖ components of the k^{th} pi/4 DQPSK symbol are:

$${I}_{k} = cos ( {ϕ}_{k} )$$

$${Q}_{k} = sin ( {ϕ}_{k} )$$

$$where ,$$

$${ϕ}_{k} = {ϕ}_{k - 1} + {θ}_{k}$$

The functions cos( ) and sin( ) represent cosine and sine of the argument value and can be implemented using a look up table stored in the DSP. The phase and quadrature symbol sequences, φₖ, Iₖ, and Qₖ, are generated at a predetermined symbol rate, which, in this example, is 16 kbps.

An impulse train generator module 912 up-samples each of the Iₖ and Qₖ sequences to generate an impulse train at predetermined sampling rate. The sample rate is, in this example, 384 ksps.

The up-sampled sequences, Îₖ and \hat{Q}ₖ, are pulse shaped with pulse shaping filter 914. This example uses a square root raised cosine (RRC) filter with a roll-off factor, α, and a symbol period of T. The impulse response of the RRC filter is given by:

$$g ( t ) = \{ \begin{matrix}1 - α + \frac{4 α}{π} , & for t = 0 \\ \frac{α}{\sqrt{2}} [ ( 1 + \frac{2}{π} ) sin ( \frac{π}{4 α} ) + ( 1 - \frac{2}{π} ) cos ( \frac{π}{4 α} ) ] , & for t = \pm \frac{T}{4 α} \\ \frac{sin [ π ( 1 - α ) \frac{t}{T} ] + 4 α \frac{t}{T} cos [ π ( 1 + α ) \frac{t}{T} ]}{π \frac{t}{T} [ 1 - {( 4 α \frac{t}{T} )}^{2} ]} , & otherwise\end{matrix}$$

After the pulse shaping is applied, the in-phase u_{I} and quadrature u_{Q} components of the modulated pi/4 DQPSK baseband signal can be described by:

$${u}_{I} ( t ) = {\sum }_{n} g ( t - nT ) cos ( {ϕ}_{n} )$$

$${u}_{Q} ( t ) = {\sum }_{n} g ( t - nT ) sin ( {ϕ}_{n} )$$

The in-phase and quadrature components of the modulated baseband signal (u_{I} and u_{Q}) are sent from the DSP to field programmable gate array (FPGA) through an appropriate interface. The FPGA is programmed to format the signal into an appropriate format before providing them as an I and Q signals to a digital to analog converter (DAC). The outputs of the DAC are received by an RF modulator with a linearized transmitter. At the RF modulator, the signals are modulated by a carrier frequency f_{c}, amplified by the power amplifier, and transmitted.

FIG. 10 is a chart that illustrates a Pi/4 DQPSK waveform 1000 and spectral mask 1002 generated from a simulator modeled according to modulation 900 with a transmit data rate of 9600 bps (9.6 kbps) and an RRC filter roll-off 0.35.

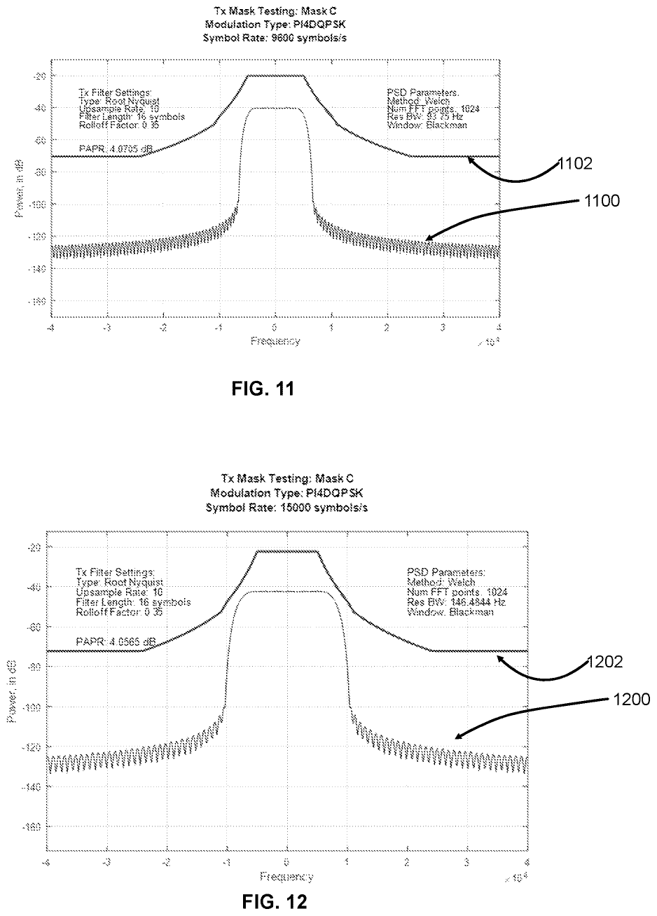

FIG. 11 is a chart that illustrates a Pi/4 DQPSK waveform 1100 and spectral mask 1102 generated from a simulator modeled according to modulation 900 using a transmit data rate of 19200 bps (19.2 kbps) and an RRC filter roll-off 0.35.

FIG. 12 is a chart that illustrates a Pi/4 DQPSK waveform 1200 and spectral mask 1202 generated from a simulator modeled according to modulation 900 using a transmit data rate of 30000 bps (30.0 kbps) and an RRC filter roll-off 0.35.

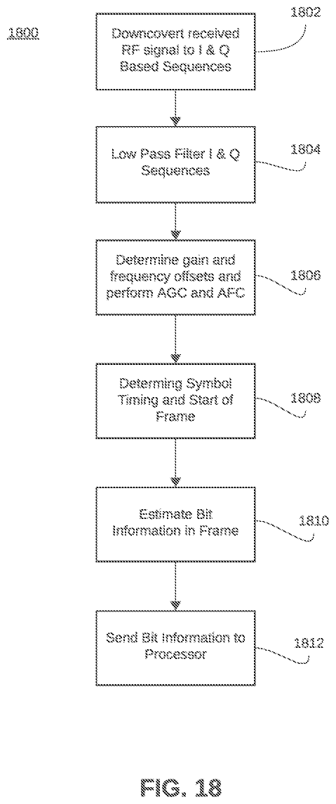

Referring now to the flow chart of FIG. 18, illustrated is a representative, nonlimiting example of a demodulation process 1800 performed by a receiver section of a 44 MHz radio to demodulate DQPSK, including Pi/4 DQPSK, modulated signals that uses a modular implementation for an SDR demodulator. A received RF signal is down-converted, which is represented by process block 1802, to create a two parallels digital baseband signal sequences or streams, an in-phase (I) sequence and a quadrature phase (Q) sequence. The baseband I and Q sequences are low pass filtered by a pre-detection filter, which is represented by process block 1804. At process block 1806, gain and frequency offset of the received signal are estimated from the output of the pre-detection filter. After obtaining the gain and frequency offset estimates, AGC and AFC are performed through feedback logic. The I and Q digital signals from the pre-detection filter are then passed to a demodulator synchronizer and detector modules of the demodulator.

At process block 1808, the demodulator determines the start of the frame and symbol timing for a received packet by detecting synch bits in the packet's preamble and determining their timing. The demodulator starts in an initialization state, in which both synchronizer and detector modules are initialized. After initialization, the demodulator operates in a synchronization state, in which the demodulator receives digital baseband I and Q signals. At block 1810, once symbol synchronization is determined, the demodulator enters a symbol detection state in which the I and Q signals are sampled according to the determined symbol timing and the bit information in the transmitted frame is estimated from the sampled I and Q signals. At block 1812, the bit information from the detector is then sent to the radio's processor through, for example, an HPI. After the received frame is processed, the demodulator returns to the initialization state.

In a representative example of a symbol detection process for a pi/4 DQPSK waveform, the detector receives the sampled input sequences, Iₖ and Qₖ. For each Iₖ and Qₖ input sample, the detector determines the cosine and sine of phase change over one symbol interval. This determination can be made using, for example, an arctangent function or complex conjugate multiplication.

The cosine and sine results can be obtained using the relationships:

$${x}_{k} = cos ( {ϕ}_{k} - {ϕ}_{k - 1} ) = {I}_{k} \times {I}_{k - 1} + {Q}_{k} \times {Q}_{k - 1}$$

$${y}_{k} = sin ( {ϕ}_{k} - {ϕ}_{k - 1} ) = {Q}_{k} \times {I}_{k - 1} - {I}_{k} \times {Q}_{k - 1}$$

where φₖ is the signal phase and is determined using the following relationship:

$${φ}_{k} = arctan ( {Q}_{k} / {I}_{k} )$$

With the arctangent approach, the xₖ and yₖ results are obtained by first extracting the signal phase from Iₖ and Qₖ samples using an arctangent function as shown in the equation above. Next, the phase change over one symbol interval, φₖ−φₖ₋₁, can be determined, for example, using a difference function:

$${θ}_{k} = {ϕ}_{k} - {ϕ}_{k - 1}$$

Following the difference function, modulo-2pi correction logic can be applied to wrap the phase around the real axis. After the phase difference is obtained, xₖ and yₖ can be obtained by applying cosine and sine functions respectively to the phase difference:

$${x}_{k} = cos ( {θ}_{k} )$$

$${y}_{k} = sin ( {θ}_{k} )$$

With the complex conjugate multiplication approach, the Iₖ and Qₖ samples are first delayed by one symbol interval to obtain Iₖ₋₁ and Qₖ₋₁. The four components, Iₖ, Qₖ, Iₖ₋₁, and Qₖ₋₁, are passed to the complex conjugate multiplication function to obtained xₖ and yₖ as

$${x}_{k} = {I}_{k} \times {I}_{k - 1} + {Q}_{k} \times {Q}_{k - 1}$$

$${y}_{k} = {Q}_{k} \times {I}_{k - 1} - {I}_{k} \times {Q}_{k - 1}$$

Different methods can be used to process the xₖ and yₖ values. These methods may use, for example, hard-decision or soft-decision decoding approaches to decode xₖ and yₖ into dibits, aₖ and bₖ, respectively. In an example in which hard-decision decoding is used, after xₖ and yₖ are obtained by either arctangent or complex conjugate approaches, the xₖ and yₖ are then be decoded directly into dibit, aₖ and bₖ, respectively by using a decoding logic as follows:

$${a}_{k} = \{ \begin{matrix}0 , & {x}_{k} > 0 \\ 1 , & {x}_{k} \leq 0\end{matrix}$$

$${b}_{k} = \{ \begin{matrix}0 , & {y}_{k} > 0 \\ 1 , & {y}_{k} \leq 0\end{matrix}$$

A soft-decision approach would use the original unquantized symbol values xₖ and yₖ or scale and quantize them to a specified number of bits per symbol value. Using this approach might be preferrable when certain types of forward error correction methods are used, such as convolutional encoding, in which case soft-decision Viterbi decoding would be used.

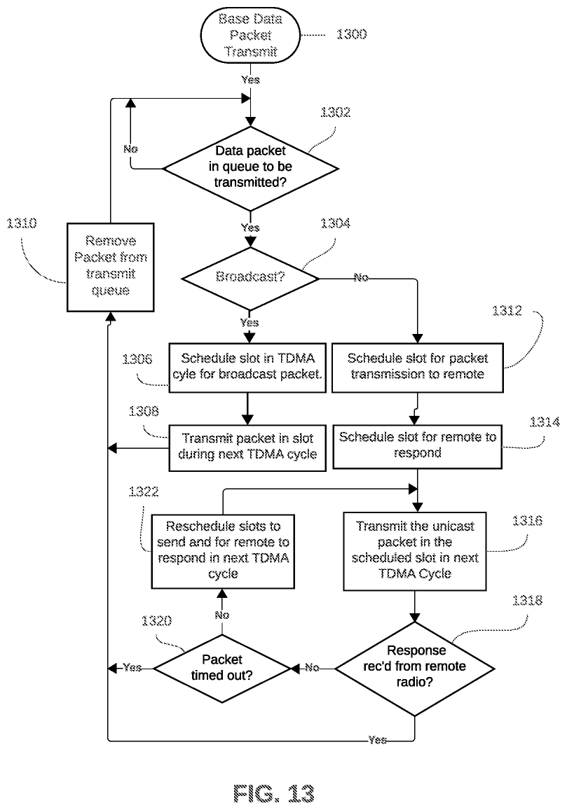

Turning now to FIGS. 13 to 17, the illustrated flow charts describe representative and nonlimiting examples of methods for coordinating shared use of a 44 MHz channels by 44 MHz radios to transport data between railroad applications a base radio and remote radios in the vicinity of the base radio, including mobile remote radios on or in the vicinity of the track and fixed remote radios along or near the track. The methods contemplate two different types of communications: centralized communication and decentralized communication. References to “radio” in the following description of these figures should be understood to refer to digital 44 MHz radios for transmitting and receiving packets containing railroad application message data.

Base radios and remote radios are configured, such as by programs run by a processor, to be capable supporting either or both centralized and decentralized communication for one channel or any of two or more channels. Each radio has programmed in it the processes according to protocols based in whole or in part on methods described below. For example, a 44 MHz radio may, optionally, be configured for receiving wireless packets on just one channel or simultaneously receiving and processing wireless packets sent on multiple channels, any of which may be designated for centralized or decentralized communications. A 44 MHz radio may optionally be configured to transmit on any one of one of the two or more channels, but not at the same time, any of which can be designated for centralized or decentralized transmission.

In these examples, a centralized communication scheme uses Time Division Multiple Access (TDMA), an approach in which the frequency channel is divided into time-slotted segments or “slots.” A base station radio acts controller, managing the allocation of the time slots to the 44 MHz radios within its vicinity. A TDMA cycle multiple several slots. The number of slots and the length of the slots can be set to suit the communication demands of the system. A cycle may, optionally, be divided into multiple frames. The length of frame can set to any desired length. The lengths of cycle, frames, and slots may, optionally, be adjustable. Each TDMA cycle and, optionally, frame begins with a control message broadcast by the base station and is followed by one or more time slots.

A slot for transmission can be assigned by the base radio for use by the base radio or a remote radio. A TDMA frame may, optionally, be configured with any given slot or series of slots in a frame or cycle can be, if desired, designated for the base radio use or for assignment to a remote radio. A slot may be assigned or allocated to a particular radio for use during a cycle. However, it could alternatively be configured as or assigned as a contention slot, during which any 44 MHz radio may attempt to transmit if the remote radio senses that no other remote radio is transmitting in the slot. A slot in a frame may also be designated as a contention slot during each cycle without having to be assigned. Slot assignments for remote radio of a slot in a frame can be, for example, broadcast as part of TDMA control packet or other control packet at the start of TDMA cycle or frame. The assignments could be for the current cycle, the next cycle, both cycles, or a future cycle. For a remote to request the request a slot to transmit, it transmits a slot request to the base station. The processes may be configured only to allow for one slot to be requested. However, they may optionally be allowed to request an assignment of multiple slots, such as for periodic transmissions. For period transmissions, the request may, optionally, indicate a requested transmission rate. The processes may, optionally, also be configured to allow a request to include a priority level for the transmission selected from two or more predetermined priority levels.

Centralized communication may support or allow for multiple types of transmissions, including broadcast transmissions and unicast packet transmissions. However, the TDMA may, optionally, support or allow only one type of transmission, such as a unicast transmission. For a broadcast transmission, any radio that receives the packet may process it. For a unicast transmission, only the radio to whom the packet is addressed is intended to process it.

For a broadcast transmission, a base radio schedules a slot for its broadcast packet. A remote radio may request a slot from the base and may then, once assigned, transmit the broadcast packet in the assigned slot. For a unicast transmission, a base radio schedules a slot for it to transmit the unicast packet to a remote radio and schedules a slot for the remote to acknowledge receipt and, optionally, to send data. The base radio then transmits the unicast packet in the slot that it scheduled for itself. If the remote receives the packet, it is expected to send a response in the slot assigned to it for the response. If the remote radio has data to send to the base radio, the response is a data packet. If it does not have data to send to the base radio, it sends an acknowledgement packet. Should the base radio not receive a response from the remote radio in the assigned slot and the packet has not timed out, the base radio schedules retransmission of the packet in another slot and assigns a new slot for the remote radio's response. This retransmission cycle is repeated until a response is received or the packet times out. The remote radio may request a slot from the base. The remote may transmit the unicast packet in the assigned slot. If the base receives unicast packets from multiple remotes, the base radio may acknowledge all the received packets in the next TDMA cycle. The acknowledgement may be sent as a field in the TDMA control packet or as a separate packet. If the base does not receive packet from the remote in the assigned slot, the base assigns another slot to the remote in the next TDMA cycle. If the remote does not receive an acknowledgement from the base, the remote requests additional slot from the base.

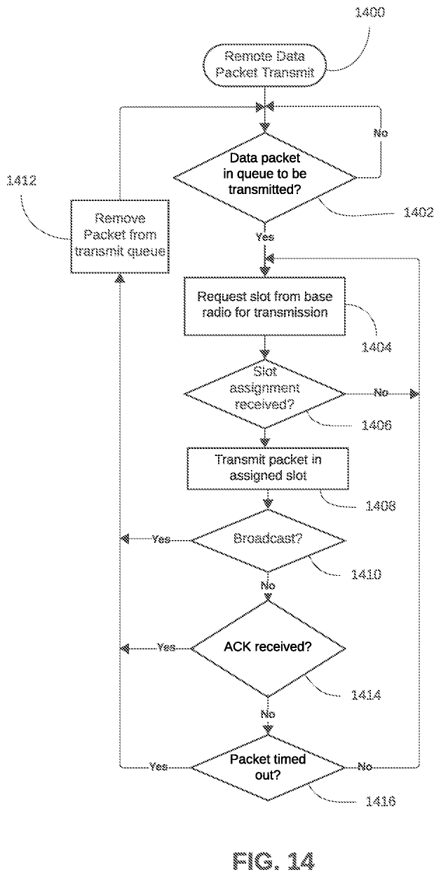

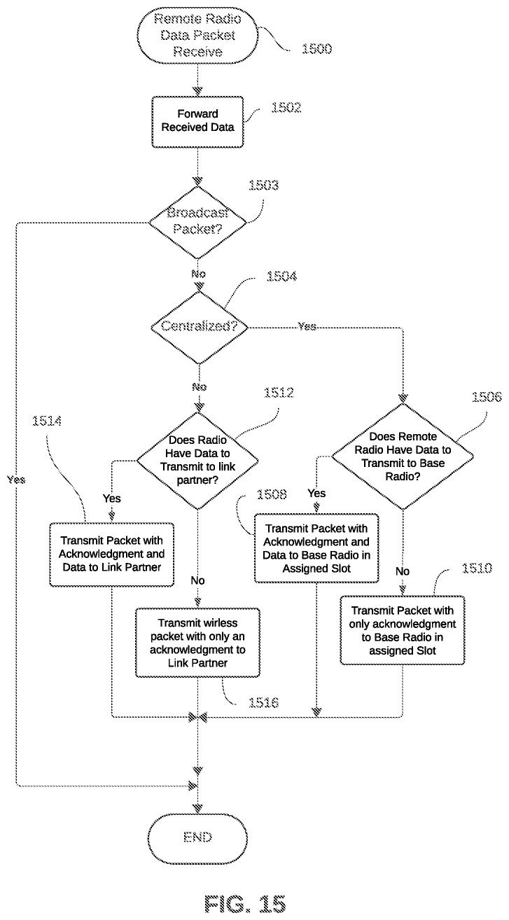

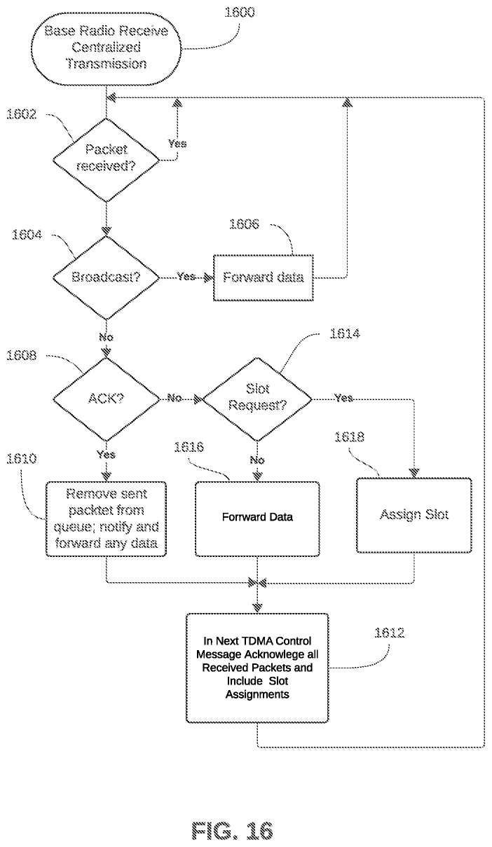

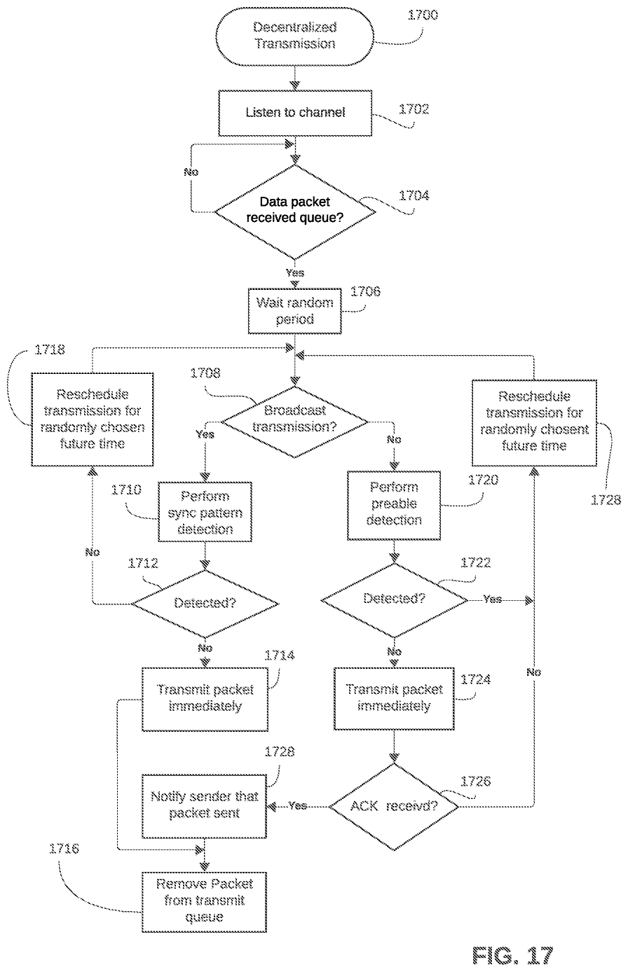

FIGS. 13-14, which illustrate a representative and nonlimiting examples of processes 1300 and 1400 for a base radio and a remote radio, respectively, to transmit a packet using centralized communication. FIGS. 15-16 illustrate representative and nonlimiting examples of processes that a base radio and a remote radio may use when receiving packet using centralized communication and, in the case of a remote radio, when decentralized communication is being used or supported. If only decentralized communication is being used by a remote radio, only those portions of the process shown in FIG. 15 relating to decentralized communication would be implemented or, if implemented, performed. FIG. 17 is a representative example of a decentralized communication transmission process for a radio.

Turning first to FIG. 13, the base radio process 1300 of FIG. 13, is a representative example a base radio to transmit a data packet with train application data using a 44 MHz radio using a TDMA-based centralized communications scheme. At block 1302, for a packet in its transmission queue that is not scheduled for transmission, the base radio assigns itself a slot in a TDMA cycle to transmit it. As indicated decision block 1304, the process will depend on whether it is broadcast packet, which is not acknowledged, or a unicast packet, which is intended for a particular remote radio. If it is a broadcast packet schedules a TDMA slot for its transmission, represented at block 1306, transmits it, as represented by block 1308, and removes it from the transmission queue at block 1310. If it is a unicast packet, the process schedules slots for the base radio to transmit the packet and for the intended remote radio to transmit a packet acknowledging receipt of the packet, as represented by blocks 1312 and 1314. The base radio then transmits the packet, as represented by block 1316. If it receives a packet transmitted by the remote radio in the assigned slot that acknowledges receipt of the base radio's packet, it removes the packet from the transmit queue as represented by blocks 1318 and 1310. If no acknowledgment of the packet has been received and the packet has not timed out, the bas radio will schedule slots to retransmit the packet and for the remote radio to transmit an acknowledgement, as represented by blocks 1320 and 1322. The base radio then transmits the packet again in the slot that it assigned itself and waits for an acknowledgement from the remote radio. Retransmission attempts are repeated until the packet times out or the remote radio acknowledges its receipt. Retransmission process represented by blocks 1318, 1320, and 1322 helps to improve reliability. However, it is an example of steps of a process that may, optionally, be omitted entirely or not performed under certain conditions, such as when additional reliability is not required or outweighed by other considerations.

FIG. 14 is a flow chart that illustrates a representative example of a process 1400 for a remote 44 MHz radio to transmit a data packet with train application data in its transmission queue on a channel that using the TDMA-based centralized communication scheme. To send a packet in its transmission queue using centralized communication, as represented by block 1402, the remote radio requests a slot to transmit the data packet to the base radio, as represented by block 1404 and waits to receive the slot assignment as represented by block 1406. Slot requests can be sent, for example, during a frame or slot assigned during the TDMA cycle for remote radios to transmit using a contention-based access method, such as one that can be used for decentralized transmission. Although not indicated in the figure, if the remote radio needs to acknowledge a transmission from the base station, or otherwise has been assigned a slot it may use to transmit the packet to the base radio, it does not need to request a slot. The data packet can be transmitted with an acknowledgment in the slot assigned to it by the base radio to acknowledge transmission. Once the packet is scheduled for a slot, the remote radio transmits at block 1408 in the assigned slot. If the remote radio does not need to or does not expect to retransmit the data packet, it may remove it from the transmit queue. For example, if the transmitted wireless packet was a broadcast packet, no response is expected and therefore it may remove the data packet from its queue, as indicated by blocks 1410 and 1412. Otherwise, the remote radio checks for an acknowledgment of the transmission from the base radio in, for example, the next control packet that it sends. If, as represented by block 1414, the remote radio has received such an acknowledgement, it may remove the packet from its transmit queue (block 1412.) Although not indicated, if the transmitted wireless packet is only acknowledging a base radio transmission, it may also remove the data packet from the queue if, for example, the base radio will retransmit an unacknowledged unicast message to a remote radio and assign to the remote radio a slot to acknowledge the transmission. If no acknowledgement is received and, as represented by decision block 1416, the data packet has not timed out, the remote may repeat the process starting at block 1404 by requesting a slot for transmission. Once the data racket times out, the remote radio will remove it from the transmit queue. as represented by block 1412.

Turning to FIG. 15, representative example of a process 1500 for a remote radio receiving a wireless packet containing data begins with the remote radio receiving a transmitted packet on a channel, demodulating, and forwarding its data payload locally, as represented by block 1502. If it is a broadcast packet, it does nothing more, as indicted by block 1503. If it is not a broadcast packet, this example assumes that the received wireless packet is a wireless packet that the transmitting radio is expected to be acknowledged. An example of such a packet is a unicast packet. As indicated by block 1504, if the wireless packet that was received was sent using centralized communication, a process such as the one represented by blocks 1506, 1508, and 1510 is used. If it was sent using decentralized communication, a process such as the one represented by blocks 1512, 1514, and 1516 is used.

A channel within a geographic area controlled by a base station may, optionally, allow for decentralized communication addition to centralized communication. Centralized communication involves a remote radio transmitting and receiving wireless packets with a base radio; decentralized communication involves transmissions between radios. Both can be supported, for example, designating one or more slots of a TDMA scheme for decentralized communication or employing a super cycle with one or more periods designed for centralized communication using a TDMA scheme followed by one or more periods for decentralized communications using contention-based access methods. Other alternatives are also possible.

If the wireless data packet was sent by the base radio using centralized communication, the remote radio will have already been assigned a slot for sending a wireless packet that acknowledges receipt of the transmission and includes a data packet from its transmit queue. This is represented by blocks 1506, 1508, and 1510. If the wireless packet was transmitted using decentralized communication, the remote radio will send a wireless packet to acknowledge receipt of the transmission to the radio that transmitted it. Whether a wireless packet will contain data will depend on whether the sender is a link partner whether it has a data packet in its transmit queue for the link partner, as indicated by blocks 1512, 1514 and 1516.

Process 1600 of FIG. 16 is an example of a process of a base station receives, as represented by block 1602, a wireless transmission from a remote radio using centralized communication. If it is broadcast packet, it forwards the data from the packet for processing, as represented by blocks 1604 and 1606. If it is not a broadcast packet, it may do one of several things. If, for example, at decision block 1608, the wireless packet is received from a remote radio acknowledging receipt of a transmission from the base radio packet, it will remove the transmitted data packet from its transmit queue, notify the sender that the data packet has been transmitted and forward any data received with the acknowledgement, as represented by block 1610. At decision block 1608, if the message is not an acknowledgment, it will forward the data, as indicated by blocks 1614 and 1616. If it is request from a remote radio for a slot to transmit a message, the base station will allocate a slot as indicated by block 1618. As indicated by step 1612, the base radio will send a control packet that acknowledges each received packet and assigns any requested slots.

Referring now to FIG. 17, decentralized communication relies on a contention scheme for channel access, such as carrier sense multiple access (CSMA), in which a radio randomly senses the state of the channel when wanting to transmit and immediately transmits if it is free. CSMA is an example of a method to prevent collisions among multiple radios trying to access a shared channel at the same time. Decentralized communication may support unicast and broadcast packet transmissions. In the representative process 1700, the radio listens to a channel, as represented by block 1702 and waits at block 1704 to receive a data packet in its transmit queue. When it receives a packet, it waits for a randomly set or determined period, as indicated by block 1706. At decision block 1708, if it is broadcast transmission, the radio determines if the channel is idle or busy. To determine whether the channel is idle or busy, the radio performs, for example, sync pattern detection, as indicated by block 1712. The sync pattern detection attempts to correlate any received signal with a known sync pattern. If no sync pattern is detected, the radio is permitted to determine that the channel is idle and transmit the packet, as indicated by blocks 1710, 1712, and 1714. Once transmitted, the packet is removed as indicated by block 1716. If the channel is determined to be busy or not idle, as indicated by block 1718, the radio may, optionally, reschedule transmission of the packet transmission to another time in the future (chosen with some randomization) at which time the busy/idle determination process represented by blocks 1710 and 1712 is repeated. However, rescheduled is optional or may be limited to a certain number of attempts, time, or a parameter such as data packet's time-to-live. Any radio that receives the packet may process the data in the packet.

In unicast packet transmission, the radio determines whether the channel is busy o idle using, for example, preamble detection. This is represented by blocks 1720 and 1722. The preamble detection correlates the received signal with a known preamble. If the preamble is not detected, the radio may determine that the channel is idle and immediately transmit the packet, as represented by block 1724. Otherwise, the radio may, optionally, reschedule transmission of the packet transmission to another time in the future (chosen with some randomization) at which time the busy/idle determination process represented by blocks 1720 and 1722 is repeated. However, the process may be limited to a certain number of attempts, time, or a parameter such as a data packet's time-to-live.

Once a unicast packet is sent, the radio waits for an acknowledgment from the destination radio. If the acknowledgement is received, the radio removes the packet from the transmit queue and notifies the network layer, as indicated by blocks 1726, 1728, and 1716. If no acknowledgement is received, the radio may, optionally, reschedule transmission to another time in the future (chosen with randomization), as indicated by block 1728. Retransmission attempts can be limited as described above. When a destination radio receives a unicast packet addressed to it, the radio may acknowledge the reception right after the received packet. As mentioned above, if the receiving radio has data to transmit to the link partner, the radio may reply with a packet carrying acknowledgement and the data. If the radio does not have any data to transmit to the link partner, the radio may reply with a packet carrying acknowledgement only.

A radio may concurrently execute any one of processes disclosed. A transmit or receive process for a packet does not depend on or need to finish before a transmit or receive process for another packet can begin or end. Each of the processes may also interact with, and depend on, other processes of the radio. Furthermore, it is possible for at least some of the steps of any one of these processes to be performed concurrently, out of order, skipped, or omitted entirely in an implementation.

Furthermore, the processes illustrated by any of the flow charts in the accompanying figures are explanatory in nature and do not imply that the steps much be performed sequentially or in the illustrated order, or that any step is essential. A person of ordinary skill will understand, for example, when implementing a process that a step or combination of steps would or could be executed concurrently with other steps, executed in a different order, omitted, or made dependent on other processes or conditions.

The foregoing description of examples and embodiments, including preferred embodiments, are unless otherwise noted representative and non-limiting examples of possible implementations, embodiments, and uses embodying claimed subject matter for the purpose of explaining the principles of the claimed subject matter and how it can be put into practice to satisfying applicable requirements that the specification enable those of ordinary skill in the field to make and use the claimed subject matter. Modifications and substitutions can be made to disclosed embodiments, including what might be considered alternative embodiments, without departing from the scope of the appended claims. The use of the term “may” should be interpreted in its normal sense as expressing a possibility and not a requirement, even when not accompanied by the word “option” or “optionally.” No feature, aspect, or element is essential unless explicitly identified as such. The meaning of the terms used in this specification are, unless otherwise defined, are intended to have their ordinary and customary meaning to those in the relevant art. The meaning of a term is not intended to be limited to or defined by the specific structures or acts that it identifies in any figures are that are described. A structure or act that is referenced by a common term for a class of structures or acts is only as a representative example of that structure or act. Limitations described for an element in one embodiment do not limit the same or similar element in another embodiment unless otherwise stated in the description of that embodiment.

The terms “comprise,” “have,” “include,” “contain,” “involve,” and variations of them are open-ended linking verbs that signal a nonexclusive listing and thus permit the addition of other elements. The term “comprising” when used in claims should be interpreted in the manner typically done in patents, which is “including but not limited to.” On the other hand, the phrase “consisting of” when used in a claim implies a closed set of elements. The phrase “consisting essentially of” when used in a claim excludes additional material elements but allows the inclusions of non-material elements. A material element is one that substantively modifies, adds to, or subtracts from the functionality or nature of the subject matter recited in the claim. If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included, or it may be excluded.

All singular forms of elements, or any other components described herein including (without limitations) components of the apparatus are understood to include plural forms thereof. Use of the word “a” or “an” when used in conjunction with the term “comprising” in the claims or the specification means one or more than one unless context would otherwise make it indefinite. The use of the term “or” in the claims is used to mean “and/or” unless explicitly indicated to refer to alternatives only or if the alternatives are mutually exclusive. The terms “couple,” “coupled,” “connect,” “connection,” “connected,” “in connection with,” and “connecting” refer to “in direct connection with,” “integral with,” or “in connection with via one or more intermediate elements or members.”

What is claimed is:

1. A software defined radio configured for wirelessly transmitting wireless data packets in at least one 20 kHz channel of a 44 MHz band, the wireless data packets containing data for railroad applications, the radio comprising at least one modulator configured to capable of generating from a sequence of symbols I and Q baseband signals that are differentially encoded and modulated using at least any one or more of the modulation types: Gaussian Minimum Shift Keying (GMSK) modulation with a bandwidth time (BT) product less than 1, differential quadrature phase shift keying (DQPSK) modulation, and differential 8 PSK (D8PSK).

2. The software defined radio of claim 1 wherein the at least one modulator is further configured to be capable of generating from a sequence of symbols differentially encoded and modulated I and Q baseband signals using GMSK modulation with a BT product of 1.

3. The software defined radio of claim 2 wherein DQPSK modulation is Pi/4-DQPSK modulation.

4. The software defined radio of claim 3, wherein Pi/4-DQPSK modulation includes at least two Pi/4-DQPSK modulation types differing by symbol rate.

5. The software defined radio of claim 1, further comprising at least one receiver configured to receive transmissions in at least one 20 kHz channel in the 44 MHz band, the at least receiver comprising at least one radio frequency demodulator configured to be capable of demodulating modulated I and Q baseband signals and generating a sequence of transmitted symbols, the modulated I and Q baseband signals being modulated with at least one of the following modulation types: a Gaussian Minimum Shift Keying (GMSK) modulation with a bandwidth time BT product less than 1, differential quadrature phase shift keying (DQPSK) modulation, and differential 8 PSK (D8PSK) modulation.

6. The software defined radio of claim 5 wherein the at least one radio frequency demodulator is further configured to be capable of demodulating I and Q baseband signals modulated using Gaussian Minimum Shift Keying (GMSK) modulation with a bandwidth time BT product of 1.

7. A radio configured for wirelessly transmitting and receiving wireless data packets in a 44 MHz band with 20 kHz channels, the wireless data packets containing data for railroad applications, the radio comprising:
at least one transmitter with at least one modulator configured to be capable of generating from a sequence of symbols differentially I and Q baseband signals that are differentially encoded and modulated using at least one of the following modulation types: Gaussian Minimum Shift Keying (GMSK) modulation with a bandwidth time (BT) product of 1, GMSK modulation with a BT product less than 1, differential quadrature phase shift keying (DQPSK) modulation, and differential 8 PSK (D8PSK); and
at least one receiver configured to receive transmissions in at least one 20 kHz channel in the 44 MHz band, the at least receiver comprising at least one radio frequency demodulator configured to be capable of demodulating modulated I and Q baseband signals modulated and generating a sequence of transmitted symbols, the modulated I and Q baseband signals being modulated with at least one of the following modulation types: Gaussian Minimum Shift Keying (GMSK) modulation with a bandwidth time BT product of 1, GMSK modulation with a bandwidth time BT product less than 1, differential quadrature phase shift keying (DQPSK) modulation, and differential 8 PSK (D8PSK) modulation;
wherein the radio further configured to transmit wireless data packet in slots of 20 kHz time division multiple access (TDMA) channels in the 44 MHz band and is further configured to be capable of transmitting wireless data packets in 20 kHz channels carrier sense multiple access (CSMA) channels in the 44 MHz band.

8. The radio of claim 7, wherein the radio is configured to be capable of sending a request to a base radio for a slot for transmission in 20 kHz TDMA channels, receiving from the base radio slot assignments, and transmitting in the assigned slots.

9. The radio of claim 8, wherein the radio is further configured to be capable of acknowledging receipt of a unicast wireless data packet received from the base radio by transmitting a wireless packet in a slot assigned to the radio by the radio station for the acknowledgement.

10. In a 44 MHz band communication system comprising 44 MHz radios for railroad assets to transmit wireless data packets containing data for railroad applications, a method for supporting higher data rate transmissions in 20 kHz channels in the 44 MHz band of railroad application data, comprising;
transmitting with the 44 MHz radios wireless data packets containing data for railroad applications in a 20 kHz channel of the 44 MHz band at a transmit data rate greater than 9600 bps, wherein transmitting comprises generating from a sequence of symbols differentially encoded modulated I and Q baseband signals using at least one of Gaussian Minimum Shift Keying (GMSK) modulation with a bandwidth time (BT) product less than 1, differential quadrature phase shift keying (DQPSK) modulation, and differential 8 PSK (D8PSK); and
receiving and demodulating with the 44 MHz radios wireless data packets containing data for railroad applications in a 20 kHz channel of the 44 MHz band, the wireless data packets having been modulated with Gaussian Minimum Shift Keying (GMSK) modulation with a bandwidth time (BT) product less than 1, differential quadrature phase shift keying (DQPSK) modulation, or differential 8 PSK (D8PSK) modulation.

11. The method of claim 10, wherein the 20 kHz channel is configured for centralized communication and divided into time slots according to a time divisional multiple access (TDMA) scheme.

12. The method of claim 11, wherein the 44 MHz radios comprise one or more base radios and one or more remote radios, and wherein one of the one or more base stations assigns a time slot in the 20 kHz channel to one of the one or more remote radios, in which the remote may transmit a packet to the base station.

13. The method of claim 12, wherein the remote radio transmits to the base radio a request for an assignment of the time slot, and wherein the base radio assigns to the remote radio the time slot by identifying the assignment in a control packet sent at a beginning of a TDMA cycle.

14. The method of claim 11, wherein the 44 MHz radios comprise one or more base radios and one or more remote radios, and wherein one of the one or more base radios assigns a time slot for the base radio to transmit a unicast data packet to one of the remote radios, assigns a time slot for one of the one or more remote radios to send a packet with an acknowledgement of receipt of the unicast data packet, and identifies the time slot assignment in a control packet sent at a beginning of a TDMA cycle.
